(19) United States
(12) Patent Application Publication
(10) Pub. No.: US 2018/0068009 A1
(43) Pub. Date: Mar. 8, 2018

(54) POINT-IN-TIME DEPENDENT IDENTIFICATION FOR OFFERING INTERACTIVE SERVICES IN A USER WEB JOURNEY

(71) Applicant: 24/7 Customer, Inc., Campbell, CA (US)

(72) Inventor: Abhishek GHOSE, Bangalore (IN)

(21) Appl. No.: 15/810,851

(22) Filed: Nov. 13, 2017

Related U.S. Application Data
(63) Continuation of application No. 14/247,100, filed on Apr. 7, 2014.
(60) Provisional application No. 61/813,984, filed on Apr. 19, 2013.

(51) Int. Cl. G06F 17/30

(52) U.S. Cl. CPC G06F 17/30598; G06F 17/30867

(57) ABSTRACT

Points in a user's website journey at which an invitation for an interactive session may be offered to users, e.g. those points at which an invitation made to a user may have a higher propensity to be accepted by the user, are identified. A technique is provided that, given ample data regarding visits to a website and data regarding offers of interactive assistance made, and responses to, such offers, learns to identify accurately those points in the user's journey where such offers may be made. For the current user, offers made at these points are highly likely to be accepted. This approach bypasses the need for manual analysis that previous approaches require. In embodiments of the invention, a model provided in accordance with this technique is only re-trained on new data to account for changing user behavior.

### CROSS REFERENCE TO RELATED APPLICATIONS

This application is a continuation of U.S. patent application Ser. No. 14/247,100, filed Apr. 7, 2014, which claims priority to U.S. provisional patent application Ser. No. 61/813,984, filed Apr. 19, 2013, each of which are incorporated herein in their entirety by this reference thereto.

### TECHNICAL FIELD

The invention relates to user interactions in online services. More particularly, the invention relates to identification of points in a user Web journey where the user is more likely to accept an offer for interactive assistance.

### BACKGROUND ART

Users commonly initiate visits to a websites of one or more organizations, where the visits seek to make purchases, to locate information about goods or services, to initiate customer service support requests, to compare product information, and so on. To improve user experiences, such organizations typically enhance these Web interaction progressions, or journeys, by offering interaction services to the users. The interaction services can include invitations for Web-based chats, customized product searches, etc. The invitations can be offered at any point in the Web journey. While some of the users can find the invitations for chats, searches, and so on to be helpful, other users find the invitations distracting, disruptive, invasive, or even annoying. As a result, the organizations have sought to classify the users by their likelihood to accept an invitation and identify at what point in the Web journey a chat invitation should be initiated.

Current approaches to such classification and identification use a set of rules that decide when to offer interactive assistance to a user. These rules are created manually by investigating the data. One disadvantage of such approach is that it is not data-driven and automatic, i.e. good rules can only be created after a significant investment of manual effort. As a consequence, the approach is not scalable. Also, sizeable manual effort must be dedicated to formulating rules for each platform. Working on platforms where user behavior changes over time requires that this manual effort be invested multiple times to formulate new rules to account for such changes.

### SUMMARY

Embodiments of the invention accurately identify those points in a user's website journey where an invitation for an interactive session may be offered to users, e.g. those points at which an invitation made to a user may have a higher propensity to be accepted by the user. Embodiments of the invention provide an approach that is data-driven and automatic. A technique is provided that, given ample data regarding visits to a website and data regarding offers of interactive assistance made, and responses to, such offers, learns to identify accurately those points in the user's journey where such offers may be made. For the current user, offers made at these points are highly likely to be accepted. This approach bypasses the need for manual analysis that previous approaches require. In embodiments of the invention, a model provided in accordance with this technique is only re-trained on new data to account for changing user behavior or change in the website. As a result, the herein disclosed technique is highly scalable and convenient.

### BRIEF DESCRIPTION OF THE DRAWINGS

FIG. 1 is a block schematic diagram showing a system for enabling a user to view a website present on a Web server according to the invention;

FIG. 2 shows a weighted transducer;

FIG. 3 shows what the graph structure of an website may look like;

FIG. 4 is an example of how a hyperplane works;

FIG. 5 is a block schematic diagram showing a Web server according to the invention;

FIG. 6 is a flowchart showing a process for accurately identifying those points in a website journey at which invitations for an interactive session which have a higher propensity to be accepted are offered to users according to the invention;

FIG. 7 shows the distribution of instances before modifying the transducer;

FIG. 8 shows the distribution after the modification;

FIG. 9 shows the corresponding finite state accepter;

FIG. 10 shows T_{R} for the regular expression R from FIG. 9;

FIG. 11 shows the transducer T_{R}⁻¹, the inverse of T_{R};

FIG. 12 represents a schematic of the modified transducer;

FIG. 13 is a block schematic diagram showing information captured for visitors A,B during their Web journey according to the invention;

FIG. 14 is a block schematic diagram showing a model being invoked on page 3 of a user visit to a website according to the invention;

FIG. 15 is a block schematic diagram showing offline training or updating of a classifier according to the invention; and

FIG. 16 is a block schematic diagram showing a machine in the example form of a computer system within which a set of instructions for causing the machine to perform one or more of the methodologies discussed herein may be executed.

### DETAILED DESCRIPTION OF THE INVENTION

Users typically interact with one or more organizations to make purchases, obtain product information, initiate customer service queries, and so on. The users connect to one or more organizational websites and then make a journey on those sites to obtain the desired information. Embodiments of the invention monitor user journey information to classify the users by their likelihood of accepting invitations for interactive services at any given point in the Web journey. The interaction services include Web-based chats, voice chats, customized searches, and so on. The offerings of the interactive services are based on the classifications of the users and on identifying points in the Web journey at which certain classes of users have a high propensity for accepting the invitation. The classifications are based on a support vector machine (SVM). Offers are made to classifications of users who have a high propensity to accept, and are not made to classifications of users who have a low propensity to accept. The invitation acceptance rates are monitored and stored. The stored acceptance rate data is analyzed and used to modify classification models.

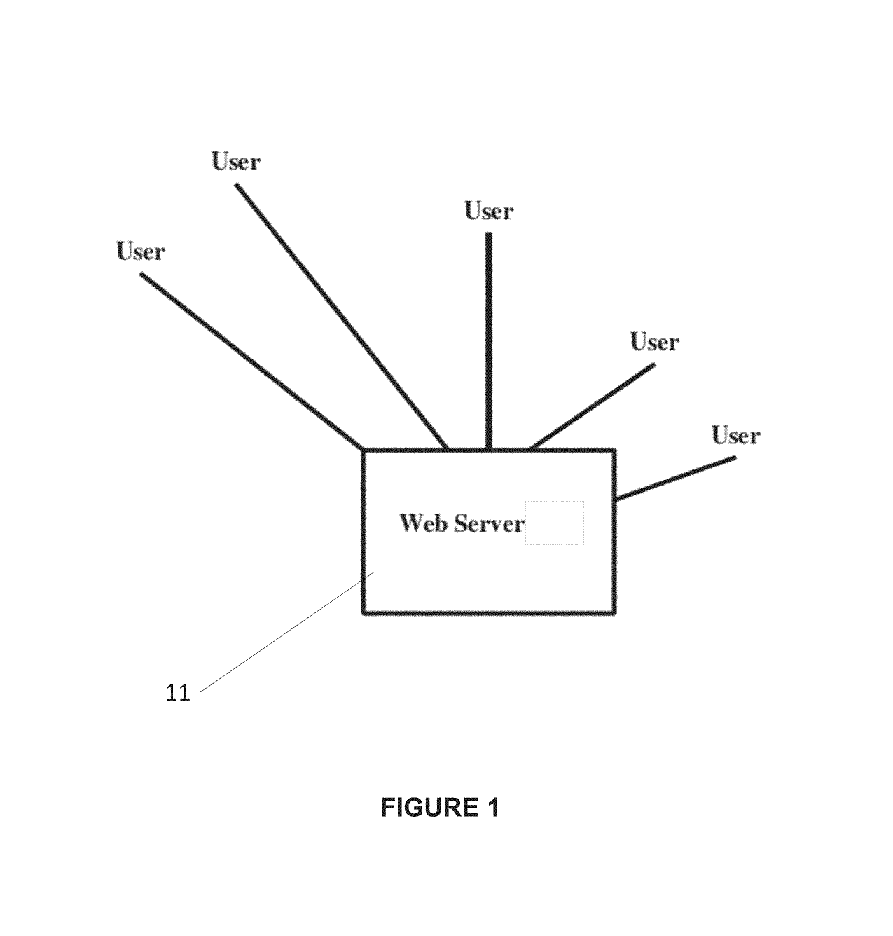

FIG. 1 is a block schematic diagram showing a system for enabling a user to view a website present on a Web server according to the invention. FIG. 1 shows a plurality of users connected to a Web server 11. The users may interact using a user device such as, for example, a mobile phone, a laptop, a computer, a tablet, a personal digital assistant (PDA), a phone, VoIP (Voice over IP), or any other device which may enable the users to interact with the Web server.

Once the user connects to a website, the Web server monitors the journey of the user. The journey of the user can include the link of a website that has led to the current website, the sequence of pages visited by the user on the website, time spent by the user on these pages, and so on.

Based on the user's journey and user's characteristics the Web server uses a support vector machine (SVM) to classify the user into a specific class. These characteristics are, for example, the location from which the user visits; the time at which the user visits; the user's OS or the browser, device, ISP, of re-direction by another website; whether the user is a repeat visitor; search terms used on a search engine to come to this website; extensions added to the user's browser; etc. This information is gathered from the various http/Web requests that user's machine makes to access the website.

In machine learning, SVMs are supervised learning models having associated learning algorithms that analyze data and recognize patterns. SVMs are used for, for example, for classification and regression analysis. Given a set of training examples, each marked as belonging to one of two categories, an SVM training algorithm builds a model that assigns new examples into one category or the other. A SVM model is a representation of the examples as points in space, mapped so that the examples of the separate categories are divided by a line such that on each side, the gap between the line and the points on the side are maximized. In cases where a perfect separation of points from different categories by a line is not possible, the SVM seeks the best possible such line. New examples are then mapped into that same space and predicted to belong to a category based on which side of the line they fall on.

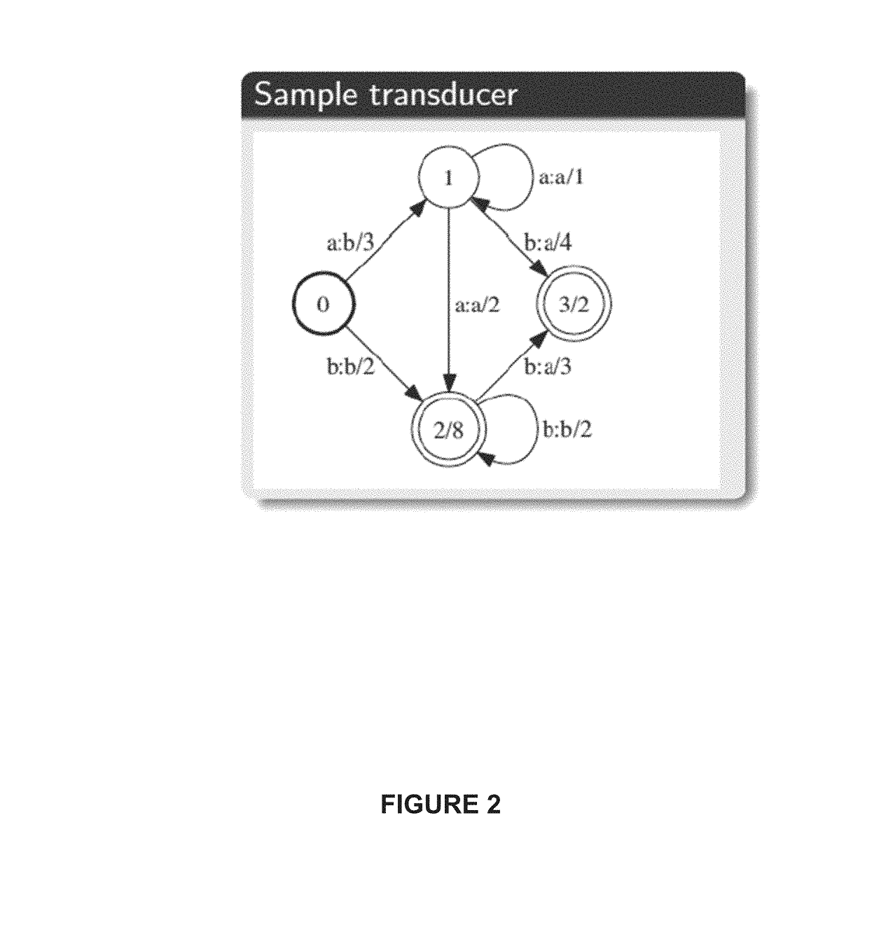

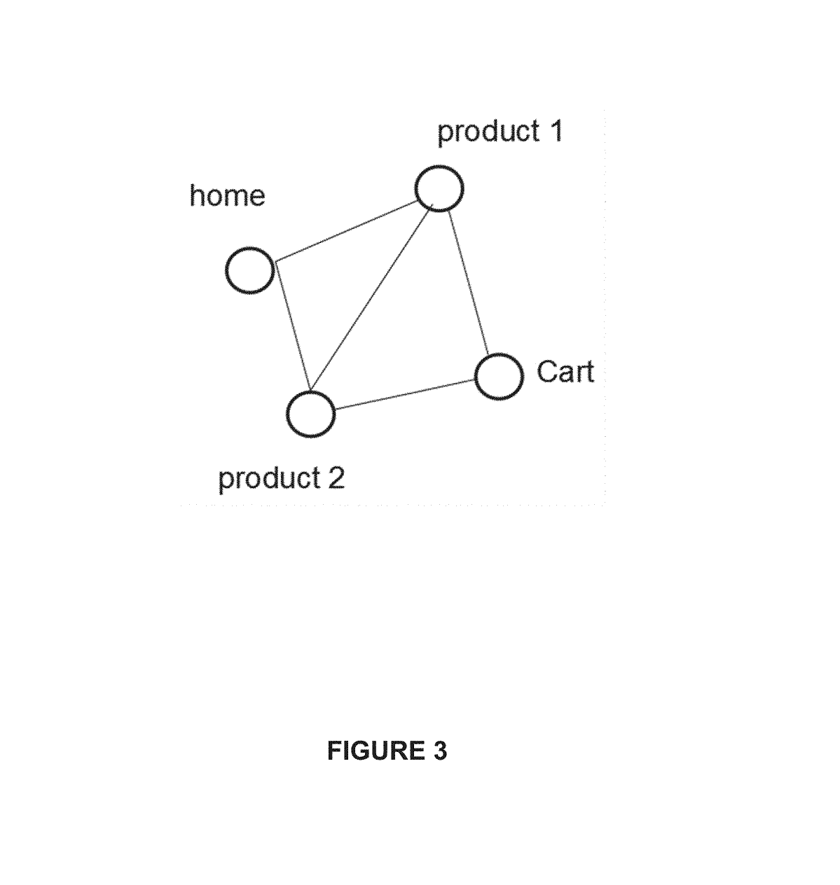

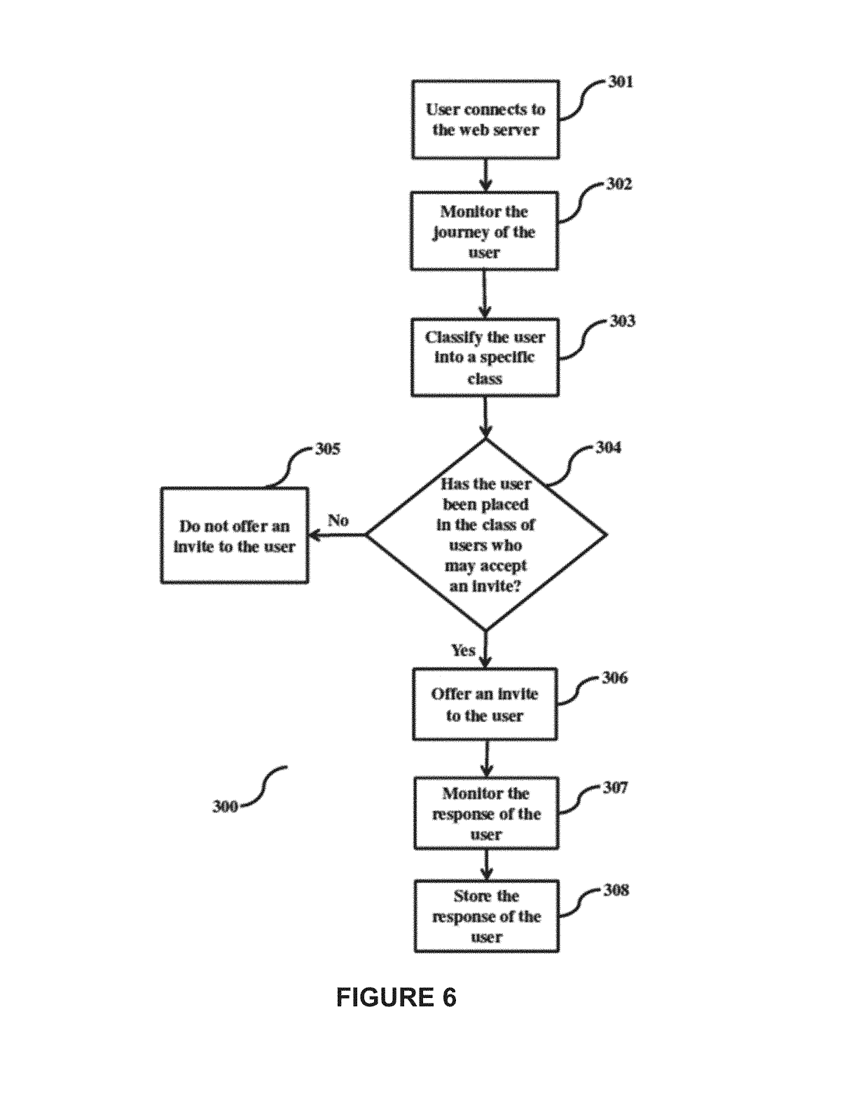

In embodiments of the invention, the SVM uses a rational kernel for classification. Rational kernels define a general kernel framework based on weighted finite-state transducers or rational relations to extend kernel methods to the analysis of variable-length sequences or, more generally, weighted automata. The rational kernel and a corresponding weighted transducer are created offline (see FIG. 6) and are based on the graph structure of the website and user visit data. FIG. 2 shows a weighted transducer and FIG. 3 shows what the graph structure of a website may look like. The Web server uses the rational kernel with the SVM to perform the above classification. In embodiments of the invention, the specific classes comprise, for example, users who accept an invitation for an interaction at a particular point in time and users who refuse an invitation for an interaction at that point in time.

In embodiments of the invention the Web server uses past history to learn a model. Past history comprises the details of user from a past visit, such as the browser history from a previous visit, location, etc., and the user's journey-related details, such as which pages were visited, the order in which they were visited, how much time was spent per page, whether the user made a purchase, whether the user chatted, etc. In an embodiment of the invention, the past history forms the training data on which the SVMs are trained to learn a model.

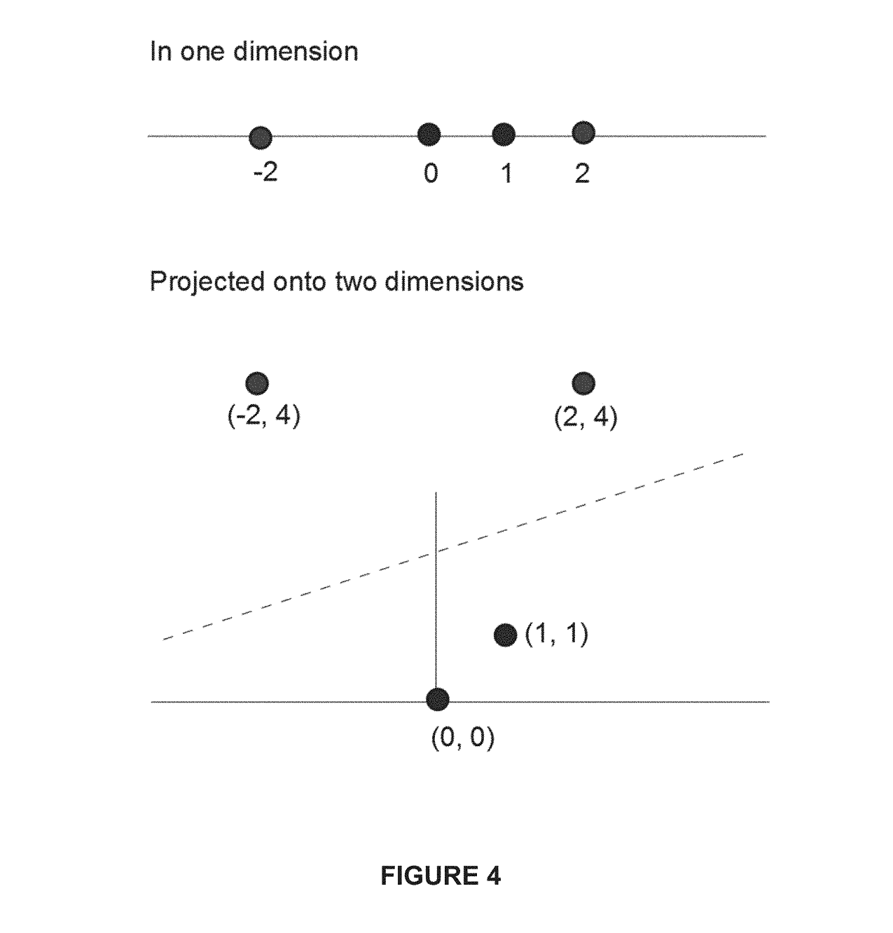

SVMs are extremely robust classifiers for binary classification problems when the points to be separated are linearly separable. Their utility is extended to non-linearly separable data by using kernels that implicitly map data to a higher dimension where such data are more likely to be linearly separable. In spaces with more than two dimensions, the term hyperplane is applied, rather than a line, which is a generalization of the notion of a line. Here, data is not linearly separable if it is not possible to find a hyperplane separating points belonging to the different categories. FIG. 4 is an example of how mapping to a higher dimension works. In the case where the points are in one dimension, there is no line that can separate the points from different categories. In the case of two dimensions, where the second dimension is obtained by squaring the value of the first dimension, there is an arrangement such that a line can separate points from the different categories. The dotted line is an example of such a line, where all points of a first type lie above it, while all points of another type lie beneath it. Modeling for sequences is a special, and often computationally intensive, case of classifying non-linearly separable data.

Based on the class into which the user is placed, the Web server makes a decision to offer the user an invitation for an interaction. If the user is placed into the class of users who may refuse an invitation for an interaction at this point, the Web server does not offer an invitation to the user. If the user is placed into the class of users who may accept an invitation for an interaction at this point in time, the Web server offers an invitation to the user. The invitation may be, for example, an offer to chat with an agent, where the chat may be any of a text-based chat or a voice-based chat.

After the invitation is offered to the user, the Web server monitors the user's response and stores the user's response in a suitable location. The Web server can thereafter apply the user's response for further analysis. The response of the user becomes part of the data that is used for updating and/or re-training the model. This is how the webserver uses the response. For example, a user may accept or reject an offered chat. The accepts and rejects are stored along with the various other information gathered. During updating of the model, this data serves as additional examples that helps the model understand at what points in what types of journeys a chat is likely to be accepted or rejected.

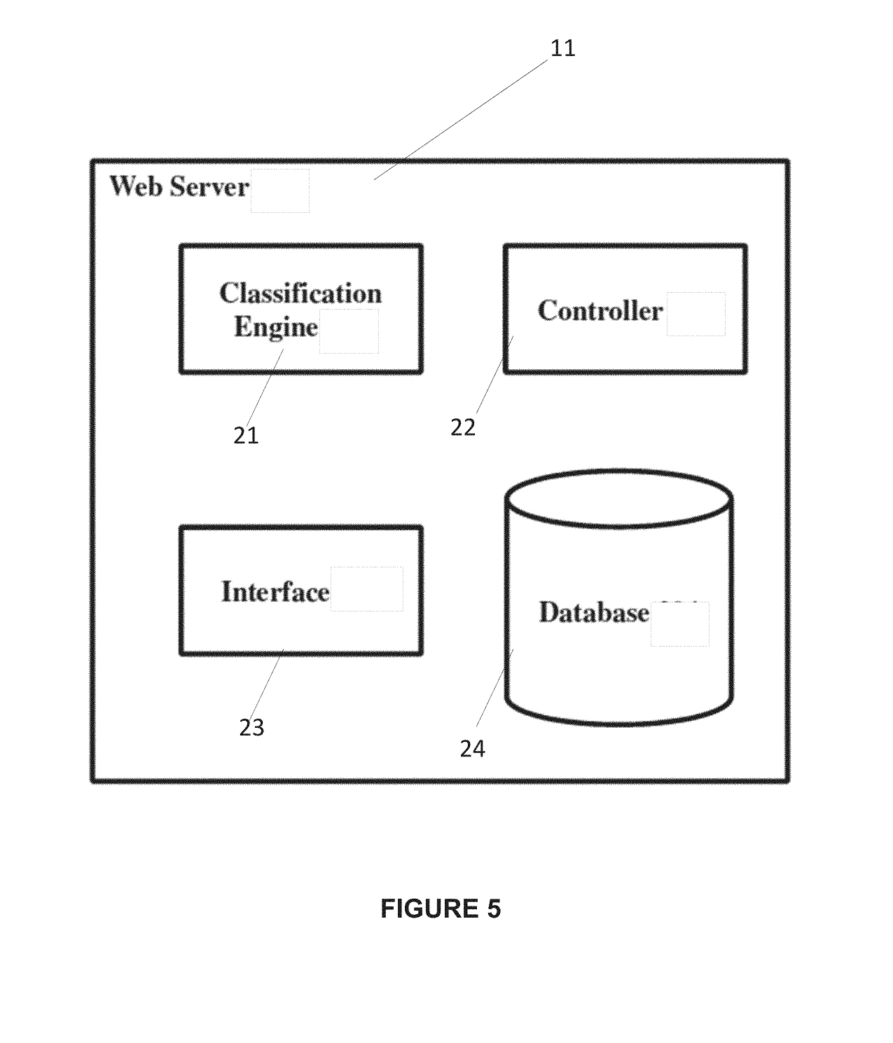

FIG. 5 is a block schematic diagram showing a Web server according to the invention. The Web server 11 comprises a classification engine 21, a controller 22, an interface 23, and a database 24. The interface 23 enables the users to interact with the Web server. The database 24 is a storage location and may be present locally with the Web server. In another embodiment of the invention, the database 24 may be present externally to the Web server and connected to the Web server using a suitable mechanism.

Once the user connects to a website, the controller 22 monitors the user's journey. In embodiments of the invention, this is done by javascript that captures user interactions on a page of the various webpages of the website and that sends the information to a server. Examples of data captured via monitoring is the URL of the pages visited, sequence in which the pages are visited on a website, whether certain buttons are clicked, time spent on various pages, etc.

Based on the user's journey and user's characteristics received from the controller, the classification engine 21 uses a support vector machine (SVM) to classify the user into a specific class. As discussed above, the SVM uses a rational kernel that is constructed offline (see FIG. 6), based on the graph structure of the website (see FIG. 3) and journey data. The classification engine uses the rational kernel with the SVM to perform the above classification. Embodiments of the invention let the model decide the characteristics of a user are important to the classification, which can be different for different websites. For example, in one case a model might decide that the precise sequence in which pages were visited in a website is important. In another case, it might decide that the time spent on a particular page is a fair indicator of the likelihood to accept chat. In embodiments of the invention, the specific classes comprise, for example, users who may accept an invitation for an interaction at a particular point in time and users who may refuse an invitation for an interaction at that point in time.

In embodiments of the invention, the classification engine uses past history and actions taken, so far, by the user in the current session to perform the classification. Based on the class into which the user is placed, the controller 22 makes a decision to offer an invitation to the user for an interaction. If the user is placed into the class of users who may refuse an invitation for an interaction at this point, the controller does not offer an invitation to the user. If the user is placed into the class of users who may accept an invitation for an interaction at this point in time, the controller offers an invitation to the user. In embodiments of the invention, the invitation is an offer to chat with an agent, where the chat may be any of a text-based chat or a voice-based chat.

After offering the invitation to the user, the controller monitors the user's response and stores the user's response in the database 24. The controller may apply the user's response for future analysis.

FIG. 6 is a flowchart showing a process for accurately identifying those points in a website journey at which invitations for an interactive session which have a higher propensity to be accepted are offered to users according to the invention.

Once the user connects (301) to a website, the Web server 11 monitors (302) the user's journey. The Web server uses the rational kernel, constructed offline, with the SVM to classify (303) the user into a specific class.

The Web server performs (304) a check into which class the user is placed. If the user is placed into the class of users who may refuse an invitation for an interaction at this point, the Web server does not offer (305) an invitation to the user. If the user is placed into the class of users who may accept an invitation for an interaction at this point in time, the Web server offers (306) an invitation to the user. In embodiments of the invention, the invitation is an offer to chat with an agent, where the chat may be any of a text-based chat or a voice-based chat.

After the invitation is offered to the user, the Web server monitors (307) the user's response and stores (308) the user's response in a suitable location. The Web server may then apply the user's response for future analysis.

The techniques disclosed herein may be applied at multiple points during a user journey. In some embodiments of the invention, application of such techniques is event triggered, for example when a user visits a Web page. Events can be user visiting a page, the user clicking on a particular button, the user pulling a dropdown, etc. The techniques herein disclosed may also be applied on a page-by-page basis, i.e. on every page visited by the user.

While a user is browsing various webpages during a Web journey, a decision is made at every page of the user's visit whether some form of interactive assistance, such as chat, should be offered to the user. This decision is made by a model that is built and/or trained offline based on data collected up to the present point in the Web journey, i.e. the data of various users and their visits.

Examples of the data collected include the geographic region from which the user visits the webpage, the browser that the user is using, the user's IP address, the time of day of the user's visit, the URLs of pages that the user visits, the page types of visited pages, etc. All of this data is collected by monitoring the user's Web journeys.

As discussed above, embodiments of the invention use a support vector machine (SVM) with rational kernels as a model. Rational kernels can represent sequences of varying lengths, i.e. Web journeys are sequences of differing lengths because different users may visit a different number of pages. These sequences can be visualized using weighted transducers.

Both of these attributes are desirable because Web journeys are of varying lengths, e.g. one user may browse five pages, and another user may browse ten pages. The innate capability of a model to handle sequences of differing lengths is valuable. The ability to visualize the kernels provides an intuitive understanding of some aspects of the decision making process that the model uses.

Finally, SVMs promise good and robust off-the-shelf performance. The use of SVMs with rational kernels helps, for example, to resolve both the need for a good classifier (SVMs) and the need for certain domain specific flexibility (rational kernels).

In FIG. 3, the various alphabetic characters, e.g. “a”, “b” that are shown as part of the edge labels denote pages in a website. The label of an edge has the format “symbol for page:symbol for page/number.” Thus, every edge has two pages indicated in its label. The number after the “/” indicates the weight of an edge. The number inside a state, i.e. the first number where there two numbers are present separated by a “/”, denotes the state number. In cases where two numbers are present, the second number indicates the weight of the state. Certain states are designated as starting states. These are shown in bold circles. State 0 is a starting state in FIG. 3. Certain states are designated as final states, shown in double circles. States 2 and 3 are final states in FIG. 3. Only final states can have weights.

Embodiments of the invention use the transducer to traverse a pair of sequences which represent journeys on a website simultaneously. A path in the transducer corresponds to a pair of journeys if the first journey can be obtained by concatenating the first character in the labels of the edges in the path, known as the input label of the path; and the second journey can be obtained by concatenating the second character in the labels of the edges in the path, known as the output label of the path. Of interest is finding paths in the transducers that begin at a starting state and end at a final state. Such paths are known as accepting paths.

Consider the pair of journeys ‘ab’ and ‘ba.’ The path in the transducer with edges from state 0 to state 1 followed by the edge from state 1 to state 3 forms an accepting path for this pair because the input label of this path is ‘ab’ and the output label is ‘ba.’

The utility of this transducer for an SVM is that the transducer assigns a weight to every pair of journeys. For a pair of journeys, a weight is calculated from the transducer in the following manner:
1. Find all accepting paths for this pair of journeys.
2. For each accepting path, calculate the product of weights of the edges in the path, multiplied by the weight of the final state in the path. This is the weight of a path.
3. Add up weights for all accepting paths.

For a pair of journeys, denote by x and y, and a transducer denoted by T, the weight assigned to this pair is denoted by T(x,y).

For example, in calculating T(‘aab’, ‘baa’) using FIG. 2, the are steps are:
1. There are two accepting paths:
   a. Path 1: 0-1, 1-1, 1-3
   b. Path 2: 0-1, 1-2, 2-3
2.
   a. Weight of Path 1: 24
   b. Weight of Path 2: 36
3. T(‘aab’, ‘baa’)=60

The final weight is interpreted as a notion of similarity between the journeys. The SVM may use this as its kernel function. Typically, this kernel value is further transformed to make the learning of the SVM optimal.

To train the SVM, specify a rational kernel, and feed it data of journeys along with the responses. The SVM uses the rational kernel iteratively to calculate kernel values for every pair of journeys, and uses this to train itself.

This also makes adjustments, based on domain knowledge, easy and convenient. The similarities calculated by a transducer depends on the weights of the edges and the final states. To reflect domain understanding, we can modify a transducer by either adjusting its structure or the weights so that certain journeys are preferentially treated.

### Adding Domain Knowledge

Look closely at what modifying a transducer achieves. T(x,y), which is equivalently denoted as a kernel function, K(x,y), is in some sense, a measure of similarity between the inputs x and y. Any modification effectively only changes how this similarity is computed.

This is important to note. Domain knowledge may be incorporated in different ways such as feature selection, adding rules, assigning labels, using a specific distance function, unequal loss functions, etc. In embodiments of the invention, it is done by modifying the notion of similarity used.

How is a domain knowledge input, such as “all sequences starting with a, followed by at least one b, should get a positive label” used, given that only the similarity function is controlled?

Assume that there is already some positively labeled instances in the dataset that conform to this pattern: “start with a, followed by at least one b.” Now modify the kernel to return a high value of similarity for sequences that follow the pattern. This groups together such instances in the projected high-dimensional space of the SVM. This, in turn, helps the soft-margin training process, using the modified kernel, to identify a hyperplane that keeps all, or most of, these instances on the same side. Because it is assumed that there already are some positive instances to begin with, on this side, all the other instances are classified as positive.

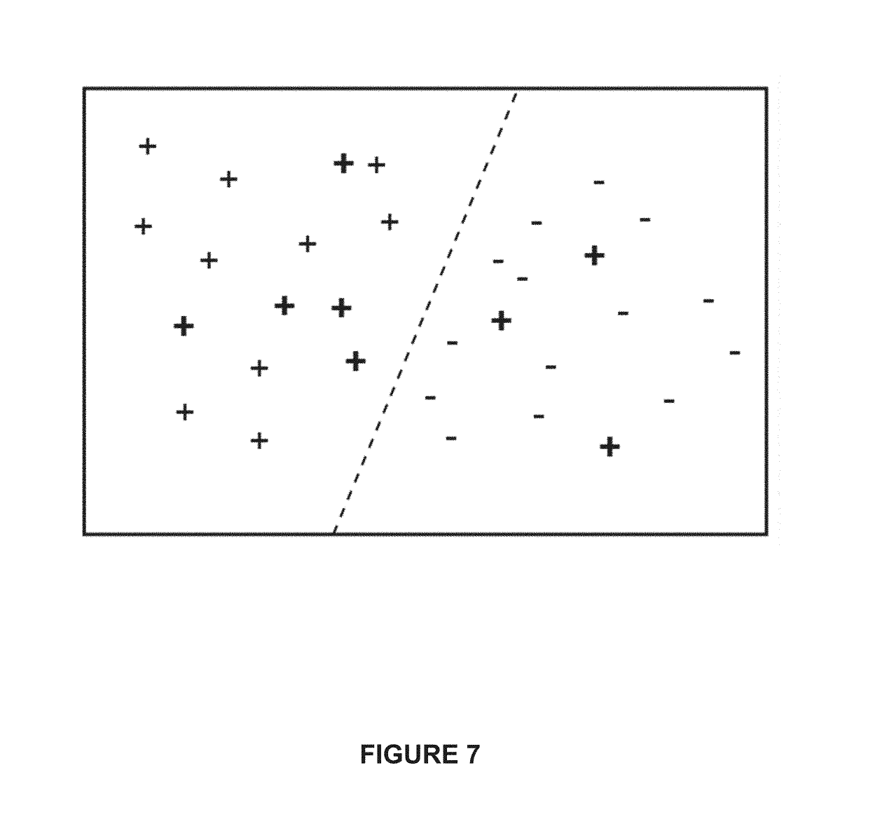

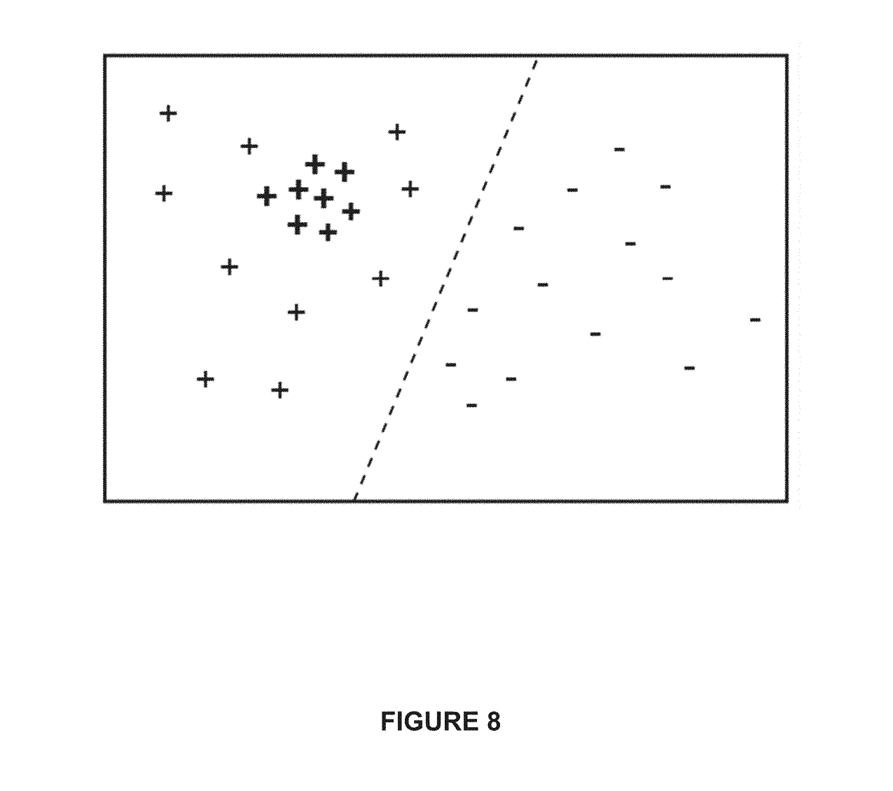

FIG. 7 shows the distribution of instances before modifying the transducer. The ‘+’ symbols in bold represent instances that conform to the pattern. It is hard to find a good classifier because these are distributed in space. FIG. 8 shows the distribution after the modification. The instances have been brought together and it is now easier for a hyperplane to classify them unambiguously. Thus, to incorporate domain knowledge, expressed as a pattern for sequences to be positively labeled, modify the transducer/kernel and re-train the SVM on the existing data. This learns a separating the hyperplane that assigns a positive label to sequences matching the pattern. Then revisit the assumption that there already are positively labeled points matching the pattern later.

### A Language for Domain Knowledge

Before continuing the discussion, consider a good way to represent domain knowledge. Earlier, reference was made an input of the form: “all sequences starting with a, followed by at least one b, should get a positive label.” There should be a standard way to express such domain knowledge so that one can modify the transducers algorithmically.

For purposes of the discussion herein, use regular expressions (regexps for short) for the following reasons:
1. Most of domain knowledge inputs are in form of patterns, such as the one mentioned, that clickstream sequences need to be checked against. These patterns are conveniently expressed as regexps.
2. Regexps can be expressed as Finite State Accepters. As discussed in a following section, this property helps to integrate them with transducers in a way that does not alter the rational kernel framework.
3. Regexps are closed under operations, such as union, concatenation, Kleene star, complement, etc. This helps break down the task of expressing domain knowledge. This is a significant benefit. Inputs can be combined from different sources of knowledge, inputs can be acquired in chunks that domain experts are comfortable with and they can be converted to a regexp later, etc. If it were not for this property, then the burden of manually tweaking transducers would be shifted to coming up with clever regexps that aggregate different inputs.
4. In the degenerate case, where sequences are explicitly provided, the herein disclosed methods work because these are valid regexps. If a list of sequences is provided, they could be combined with the union operator and the combination would still be a valid regexp.

The following lists some of the notations/terminology used:
1. For a regular expression r, let L(r) denote the language associated with it.
2. Denote the operators for union, concatenation, and star-closure with the symbols “+”, “.” and “*” respectively.

The regular expression associated with the pattern “all sequences starting with a, followed by at least one b′” is R=a·b·(b)*.

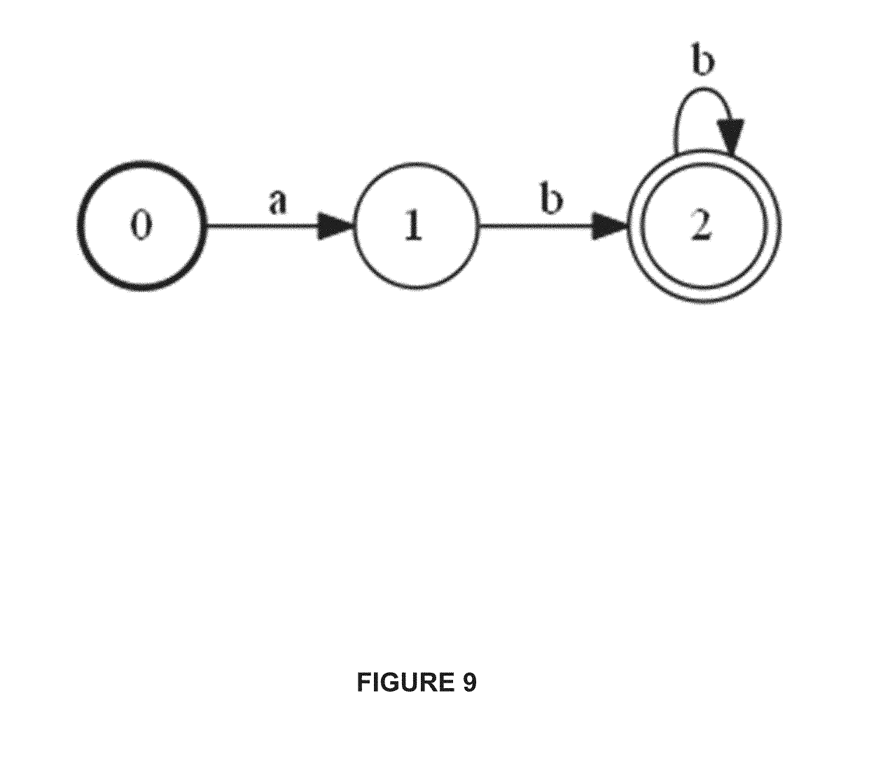

FIG. 9 shows the corresponding finite state accepter. Similar to the representation of transducers, starting states are shown in bold circles and final states in double circles. Note the transitions only have an input symbol. The final states do not have a weight associated with them. A regexp accepts a sequence, or a sequence matches a regexp, if the sequence can trace a path from the initial state to a final state, such the concatenation of the labels on its path is identical to the sequence.

### Modifying a Rational Kernel

Consider modifying a weighted transducer T given a regular expression. Embodiments of the invention provide a very simple construction to achieve this.

Begin with converting a regular expression into a weighted transducer. Given the finite state accepter for R, follow these steps to generate a transducer T_{R}:
1. Label each existing transition with an empty output symbol ε and a weight. A weight of 1 is used for now.
2. Add self-transitions to the final states. For each final state, for each symbol in the vocabulary, i.e. the set of all possible symbols, add a transition with input symbol ε, the symbol of the vocabulary as the output symbol, and a weight of 1.
3. Add weights to the final states. Assume that the same weight w_{f} is added to all final states.

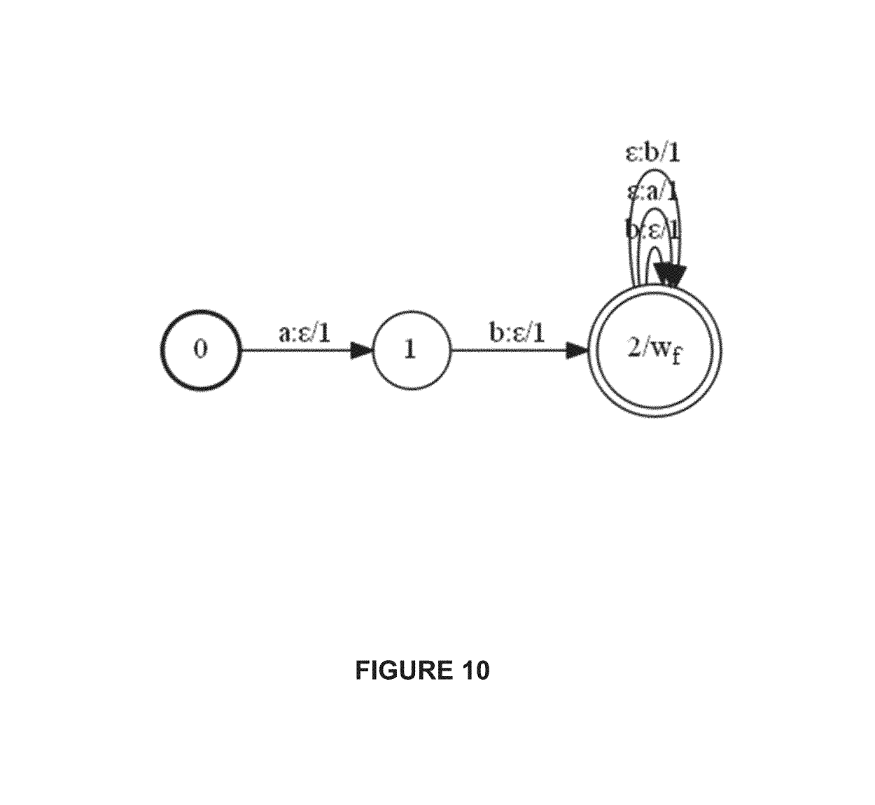

FIG. 10 shows T_{R} for the regular expression R from FIG. 9. Here, w_{f}=1. An interesting property of T_{R} is that T_{R}(x,y)≦0, if and only if xεL(R). This happens because the final state can only be reached if x was accepted by R and by adding empty output symbols on existing transitions, where no dependency is introduced on y. Once the final state is reached, the output label y may be generated by looping on the new transitions. Because these have empty input symbols, these do not change the fact that x has been accepted. Here, T_{R}(x,y)=w_{f} is the only non-zero value possible.

If x [symbol] L(R), T_{R}(x,y) does not have any accepting path, and by definition T_{R}(x,y)=0.

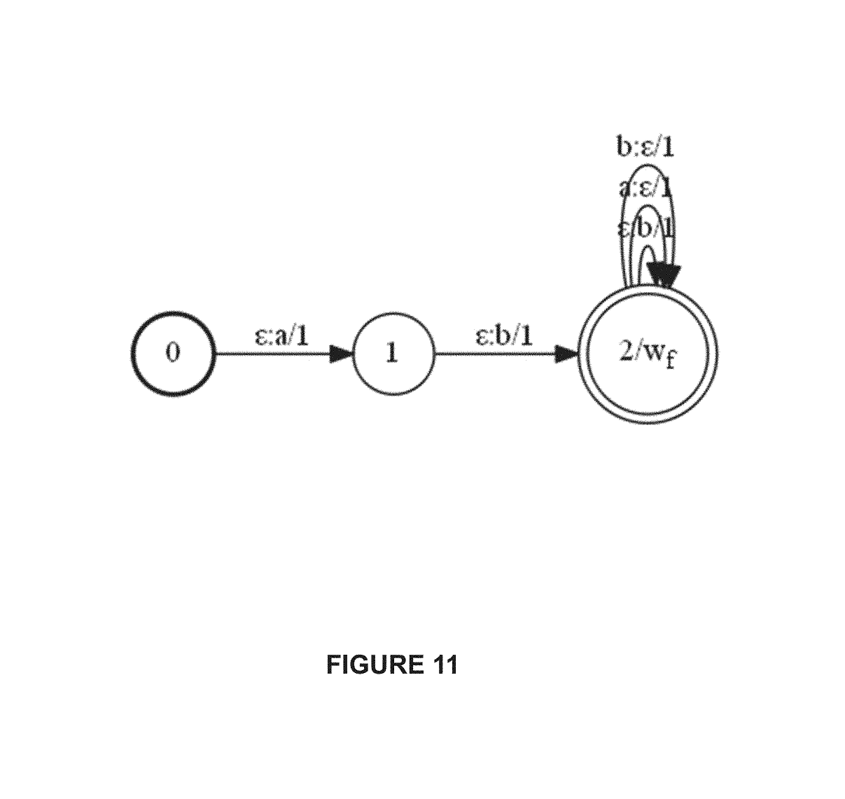

Also construct the transducer T_{R}⁻¹, the inverse of T_{R}. As shown in FIG. 11, this is created simply by swapping the input and output symbols on the transitions. Being an inverse, T_{R}⁻¹(x,y)=T_{R}(y,x). Thus, T_{R}⁻¹ has the property that T_{R}⁻¹(x,y)≦0, if and only if y E L(R).

Define the modified transducer Tₘ as,

Tₘ(x,y)=T_{R}(x,y)+T(x,y)+T_{R}⁻¹(x,y)

where, T is the original transducer.

The following shows how Tₘ(x,y) is computed:
1. If xεL(R) and yεL(R), Tₘ(x,y)=T(x,y)+2w_{f} because, T_{R}(x,y)=T_{R}⁻¹(x,y)=w_{f}
2. If xεL(R) or yεL(R), but not both, Tₘ(x,y)=T(x,y)+w_{f} because if xεL(R) and y [symbol] L(R), T_{R}(x,y)=w_{f}, T_{R}⁻¹(x,y)=0, and vice versa. 1.
3. If x [symbol] L(R) and y [symbol] L(R), Tₘ(x,y)=T(x,y) because T_{R}(x,y)=T_{R}⁻¹ (x,y)=0

This is the desired behavior, i.e. sequences that match regexp R now receive a higher kernel value relative to T(x,y).

Thus, a convenient way is shown for including domain knowledge in a natural and coherent manner into the model.

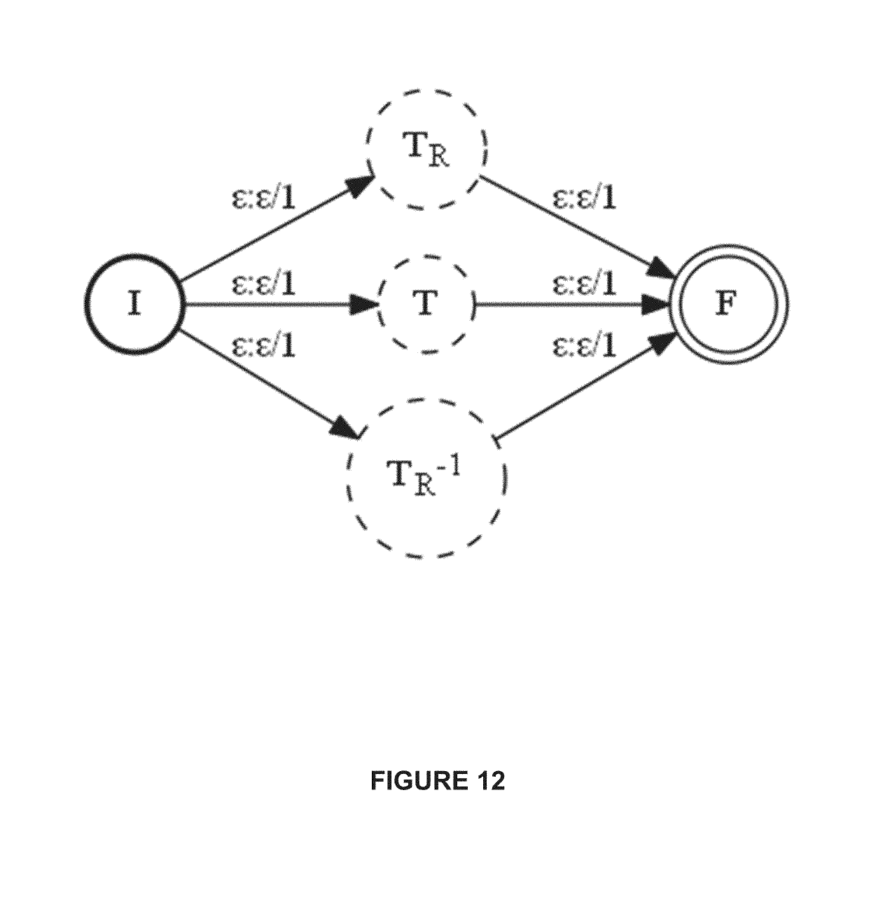

w_{f} can be changed to reflect how much Tₘ(x,y) should differ from T(x,y). FIG. 12 represents a schematic of the modified transducer.

### Using Exemplars

Consider the question of ensuring enough journeys that match regexp have a positive label. This can be done in the following ways:
1. Unless a regexp involves a new sequence symbol that is not present in the available data, such as a newly added page, existing data may already have clickstreams that match the regexp. Find these instances by checking the data against the regexp, and assigning them positive class labels, irrespective of their original labels. Tₘ is then used with a SVM to retrain on this data.
2. If the existing data lacks sequences that match the provided regexp, generate sequences that would match the regexp and add them, with positive labels, to the data. Fortunately, these do not have to be valid journey sequences on the website, which saves time in validating whether the synthetic instances could have been actually generated by a visitor. As long as they conform to the regexp and have a positive label, the modified transducer Tₘ makes sure that test points which match the regexp are also classified as positive.

The previous and this section, taken together, provide a comprehensive way to use rational kernels with domain knowledge inputs.

Embodiments of the invention use the weighted transducer to represent paths that can be taken by users in the website, and more, importantly, how the similarity between such paths may be calculated. Because the similarity calculation can be influenced in the weighted transducer representation, one may pick a transducer, and its weights, to be conducive to the particular data, i.e. the particular website, user behavior on that website, etc. Because an SVM heavily relies on the rational kernel, this enables the SVM to make optimal use of the data for learning. In many cases, this also means that the SVM can learn with relatively less data.

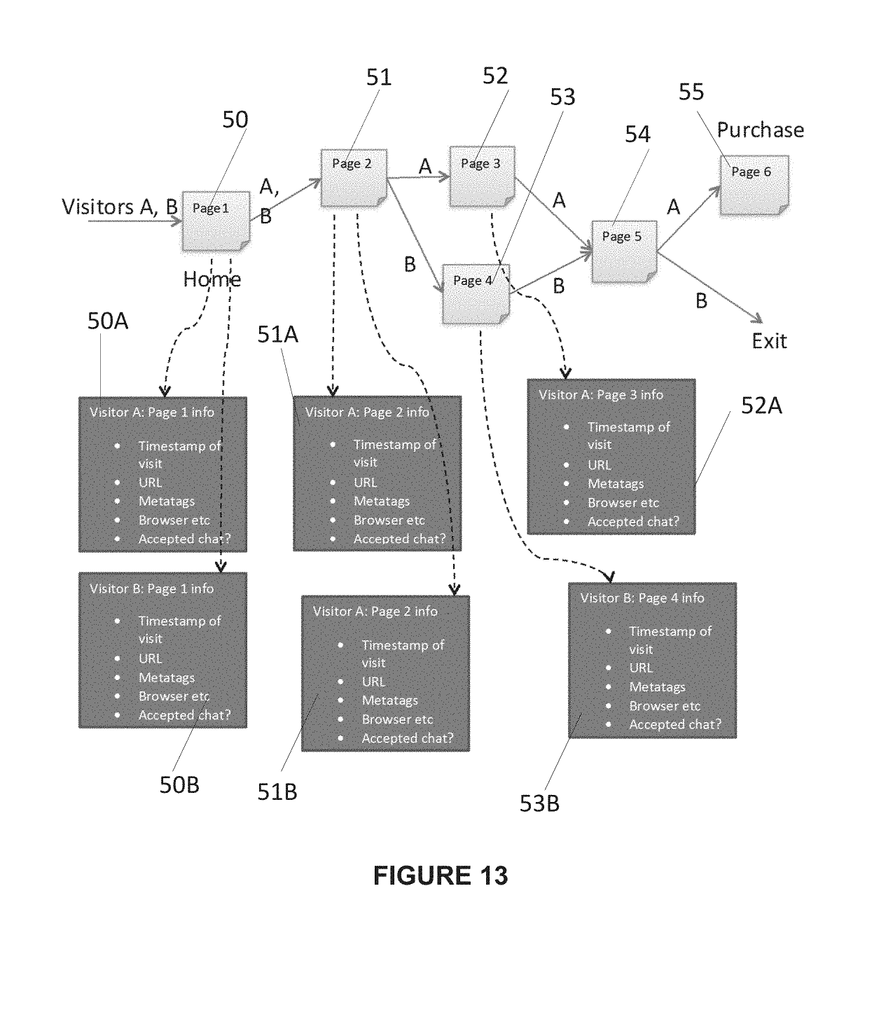

FIG. 13 is a block schematic diagram showing information captured for users A and B during their Web journey according to the invention. Information regarding each user's visit is captured for every page 50-55 that the user visits. FIG. 13 shows examples of information that was captured at each page visited for user A (50A, 51A, 52A) and user B (50B, 51B, 53B). Those skilled in the art will appreciate that the information capture shown on FIG. 13 is for a few pages in each user's journey and is for certain types of user activities and other user information, while in a presently preferred embodiment of the invention information is captured for all pages that the users visit and may be captured for other types of user activities and user information as well.

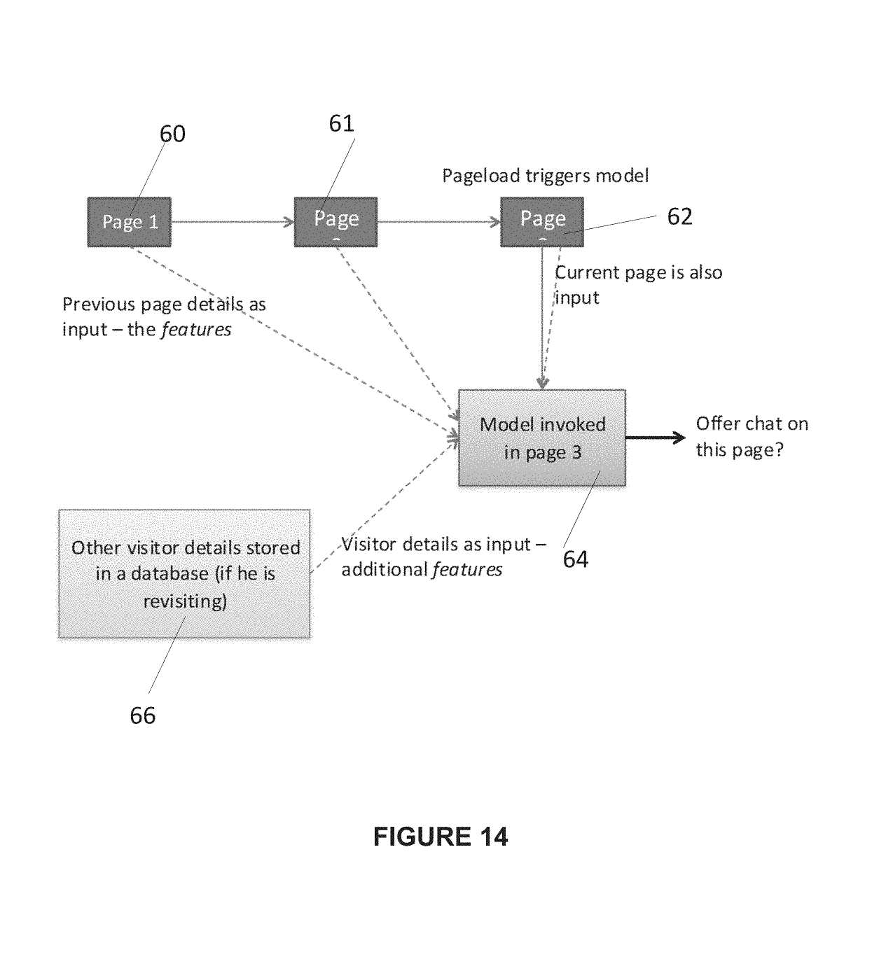

FIG. 14 is a block schematic diagram showing a model being invoked on page 3 of a user visit to a website according to the invention. In FIG. 14, the user traverses several webpages (60-62) and a model 64 is invoked on page 3 (62) of the visit. At the page load event, the model is invoked and information about the user is captured. This includes both information that was captured on the previous pages and information that was captured on the current page. This page information, and other visitor details that may be stored in a database 66 for use when the user is revisiting a page, are both provided as an input to the model. The output of the model is a decision whether chat, or some other form of interaction, is to be offered to the user on the current page. Although FIG. 14 shows the model invocation on Page 3, in embodiments of the invention the model is invoked on every page at page load. The model may be configured to be invoked at other events as well, such as clicking a button, clicking on a drop-down menu, etc.

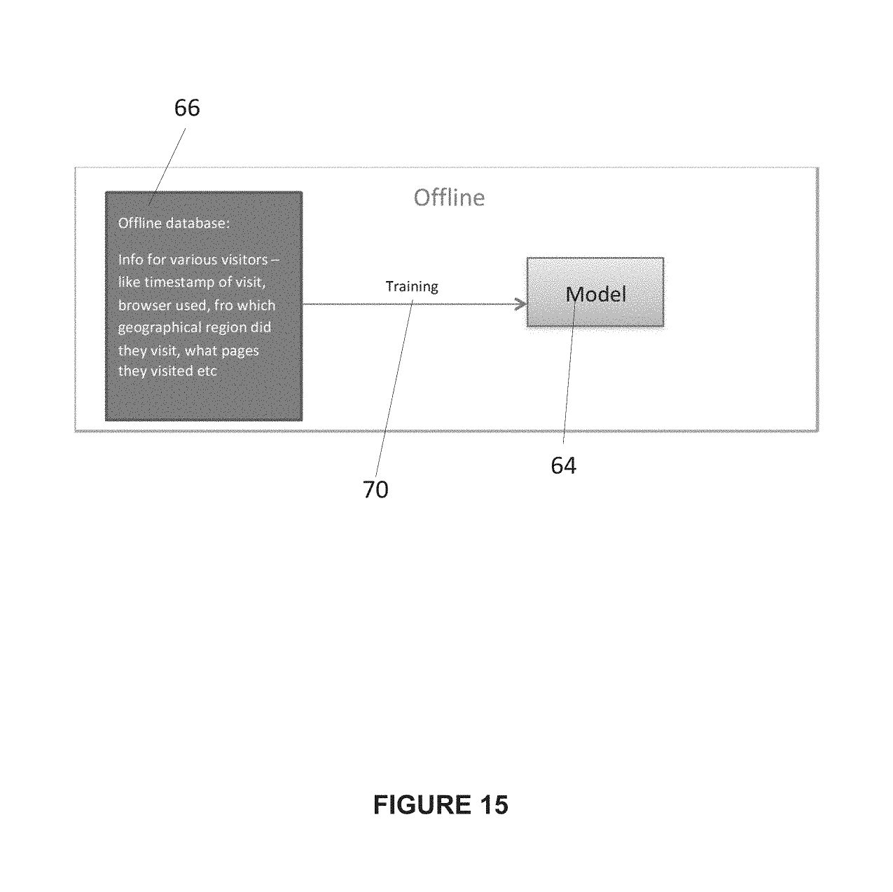

FIG. 15 is a block schematic diagram showing offline training or updating 70 of a classifier according to the invention. In FIG. 15, an offline database 66 provides information for various users, such as the timestamp of a visit, the browser used, the user's geographic region, page visited, etc. This information is then used to train the model 64. After the model is trained it is applied to user classification during the user's Web journey to determine at each point in the user's journey whether an invitation should be made, for example to enter into a chat session.

### Computer Implementation

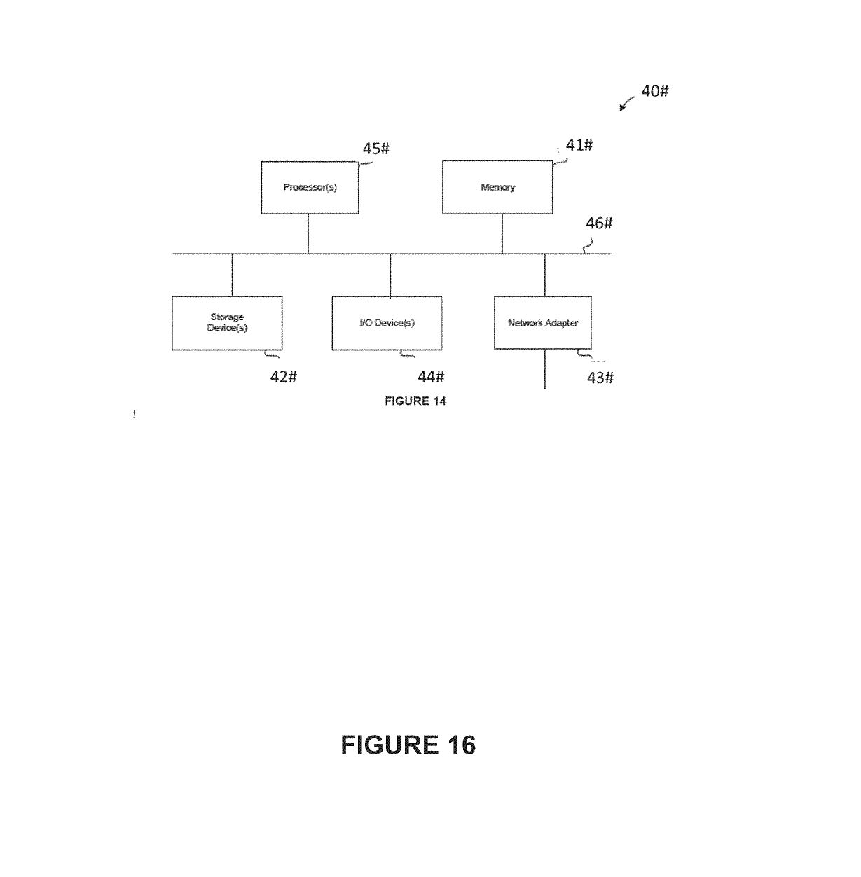

FIG. 16 is a block diagram of a computer system that may be used to implement certain features of some of the embodiments of the invention. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions, sequential or otherwise, that specify actions to be taken by that machine.

The computing system 40 may include one or more central processing units (“processors”) 45, memory 41, input/output devices 44, e.g. keyboard and pointing devices, touch devices, display devices, storage devices 42, e.g. disk drives, and network adapters 43, e.g. network interfaces, that are connected to an interconnect 46.

In FIG. 16, the interconnect is illustrated as an abstraction that represents any one or more separate physical buses, point-to-point connections, or both connected by appropriate bridges, adapters, or controllers. The interconnect, therefore, may include, for example a system bus, a peripheral component interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also referred to as Firewire.

The memory 41 and storage devices 42 are computer-readable storage media that may store instructions that implement at least portions of the various embodiments of the invention. In addition, the data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer-readable transmission media.

The instructions stored in memory 41 can be implemented as software and/or firmware to program one or more processors to carry out the actions described above. In some embodiments of the invention, such software or firmware may be initially provided to the processing system 40 by downloading it from a remote system through the computing system, e.g. via the network adapter 43.

The various embodiments of the invention introduced herein can be implemented by, for example, programmable circuitry, e.g. one or more microprocessors, programmed with software and/or firmware, entirely in special-purpose hardwired, i.e. non-programmable, circuitry, or in a combination of such forms. Special-purpose hardwired circuitry may be in the form of, for example, one or more ASICs, PLDs, FPGAs, etc.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer-implemented method comprising:
monitoring, by a server computer, a user's web journey on a website including a plurality of webpages;
using, by the server computer, a support vector machine (SVM) with a rational kernel to decide on a characteristic of the user from among a plurality of characteristics that is important to the website, the SVM with a rational kernel being constructed offline based on a graph structure and prior web journey information of the website;
for each of a plurality of points in time of the web journey, classifying the user by using the SVM with a rational kernel based on the important characteristic and information of the web journey into a first class of users who have a high propensity to accept an invitation for an interactive service or a second class of users who may refuse an invitation for an interactive service such that the user is classified two different ways at two different points in time of the plurality of points in time of the web journey;
causing the web server to offer the user an invitation for an interactive service at a first point in time of the plurality of points in time of the web journey in which the user is classified in the first class of users that have a high propensity to accept the invitation for an interactive service; and
causing the web server to not offer the user an invitation for an interactive service at a second point in time of the plurality of points in time of the web journey in which the user is classified in the second class of users that may refuse the invitation for an interactive service.

2. The method of claim 1, wherein each of the plurality of points in time of the web journey is determined by a triggering of an event.

3. The method of claim 2, wherein each event corresponds to the user visiting a webpage, the user clicking a graphical control, or the user expanding a graphical control.

4. The method of claim 1, wherein each of the plurality of points in time is in a respective webpage of the website.

5. The method of claim 1, wherein each of the plurality of points in time corresponds to a point in time when each respective webpage of the website is invoked.

6. The method of claim 1, comprising, prior to classifying the user:
invoking the SVM with a rational kernel in each webpage of the website.

7. The method of claim 1, wherein the plurality of characteristics includes a plurality of a geographic region from which the user visits a webpage of the website, a browser in which the user visits a webpage of the website, an IP address from which the user visits a webpage of the website, a time of day at which the user visits a webpage of the website, a URL of a webpage of the website that the user visits, or a type of webpage of the website that the user visits.

8. The method of claim 1, wherein an interactive service is a web-based chat, a voice-based chat, or a customized search.

9. The method of claim 1, wherein the information of the web journey includes one or more of a starting point of the web journey, a sequence of webpages of the website visited by the user, and an amount of time spent by the user on webpages of the website.

10. The method of claim 1 further comprising:
monitoring and storing data associated with a plurality of invitation acceptance rates of a plurality of users including the user; and
analyzing the stored plurality of invitation acceptance rates to update the SVM with a rational kernel.

11. The method of claim 1, wherein the rational kernel defines a general kernel framework based on a weighted finite-state transducer or a rational relation to extend a kernel method to analysis of variable-length sequences of web journeys on the website.

12. The method of claim 11 further comprising:
creating the rational kernel and a corresponding weighted transducer offline.

13. The method of claim 12 further comprising:
basing the rational kernel and the corresponding weighted transducer on a graph structure of website and user visit data.

14. The method of claim 1 further comprising:
applying the SVM to non-linearly separable data by using rational kernels that implicitly map data to a higher dimension where such data are more likely to be linearly separable.

15. The method of claim 1 wherein an invitation for an interactive service comprises an offer to chat with an agent, where the chat comprises any of a text-based chat or a voice-based chat.

16. The method of claim 1 further comprising:
updating the SVM with a rational kernel offline based on the graph structure of the website and the information of the web journey.

17. The method of claim 1, wherein the classification is based on a past history of user classification.

18. The method of claim 1 further comprising:
storing the user's response after an invitation for an interactive service is offered to the user for future analysis.

19. The method of claim 1 further comprising:
after an invitation is offered to the user, the processor monitoring the user's response and storing the user's response for future analysis.

20. The method of claim 1 further comprising:
updating, responsive to an invitation accepted by the user, the SVM with a rational kernel with information related to the accepted invitation for performing a subsequent classification of a user.

21. A computer-implemented method comprising:
monitoring, by a server computer, a user's web journey on a website;
for each of a plurality of points in time of the web journey, classifying the user into a first class of users or a second class of users such that the user is classified two different ways at two different points in time of the plurality of points in time of the web journey;
causing the web server to offer the user an invitation for an interactive service at a first point in time of the plurality of points in time of the web journey in which the user is classified in the first class; and
causing the web server to not offer the user an invitation for an interactive service at a second point in time of the plurality of points in time of the web journey in which the user is classified in the second class.

22. An apparatus for identifying a point in time of a user's web journey where the user is more likely to accept an invitation for interactive services, comprising:
a controller monitoring the user's web journey;
a classification engine, based on the user's web journey and user characteristics received from the controller, using a support vector machine (SVM) with a rational kernel to classify the user into a class including one of users who may accept an invitation for an interaction at a particular point in time and one of users who may refuse an invitation for an interaction at a particular point in time such that the user is classified two different ways at two different points in time in the user's web journey; and
based on the class into which the user is placed by the controller, the controller determining if an invitation should be offered to the user for an interaction such that:
when the user is placed into a class of users who may refuse an invitation for an interaction at a point in time, the controller does not offer an invitation to the user; and
when the user is placed into a class of users who may accept an invitation for an interaction at a particular point in time, the controller offers an invitation to the user.
